(19) United States
(12) Patent Application Publication
(10) Pub. No.: US 2023/0274876 A1
(43) Pub. Date: Aug. 31, 2023

(54) COIL COMPONENT AND MANUFACTURING METHOD OF THE COIL COMPONENT

(71) Applicant: TAMURA CORPORATION, Tokyo (JP)

(72) Inventors: Toshikazu Ninomiya, Tokyo (JP); Taichi Tamura, Saitama (JP); Masashi Yamada, Saitama (JP)

(21) Appl. No.: 18/174,310

(22) Filed: Feb. 24, 2023

(30) Foreign Application Priority Data
Feb. 28, 2022 (JP) 2022-029642

(51) Int. Cl. H01F 27/32; H01F 37/00; H01F 27/28

(52) U.S. Cl. CPC H01F 27/325; H01F 37/00; H01F 27/2823; H01F 27/006

(57) ABSTRACT

The coil component includes a plurality of coils 2 including round wires 22 arranged in alignment and wound in multiple layers and a bobbin 3 around which the coils 2 are wound. The bobbin 3 includes a winding portion 21 around which the coils are wound, a flange portion 22 provided at both ends of the winding portion 21, and the wall portion provided between the adjacent coils 2 and standing from the winding portion 21. The flange portion 22 includes an inclined guide 222 that spreads toward an opening 221. The winding portion 31 includes the groove portion 312 in which the round wire 22 as the first layer is fitted, and a step 313 provided between the flange portion 32 and the groove portion 312 and protrudes from the winding portion 31. The wall portion 33 includes an inclined side surface 332.

### CROSS-REFERENCE TO RELATED APPLICATION

This application is based upon and claims the benefit of priority from Japan Patent Application No. 2022-029642, filed on Feb. 28, 2022, the entire contents of which are incorporated herein by reference.

### FIELD OF INVENTION

The present disclosure relates to a coil component in which aligned round wires are wound in multiple layers, and a method for manufacturing the coil component.

### BACKGROUND

Coil components are, for example, reactors and transformers, and are used in power supply circuits of various electronic devices such as OA equipment, solar power generation systems, vehicles, and chargers. A reactor is an electromagnetic component that converts electric energy into magnetic energy for accumulation and release. A transformer is an electronic component that converts voltage level of AC power using electromagnetic induction.

The coil component includes a bobbin having a winding portion around which the coil is wound and flange portions provided at both ends of the winding portion in the winding axis direction, and a plurality of coils. The plurality of coils, for example two, is adjacent to the winding portion of the bobbin along the winding axis. A wall portion is provided between the two coils, and the wall portion insulates the two coils.

In addition, the coil is configured by a round wire, which is a conductive member. The coil may be an aligned-wound multi-layer coil in which round wires are arranged in alignment and the aligned round wires are laminated as several layers. When the round wires are wound in multiple layers, the round wires in the second and subsequent layers are arranged between the adjacent round wires laminated one below. As a method of winding the round wire, a method of mechanically winding using an automatic winding wire machine is known. Also, two round wires may be arranged in parallel and two round wires may be wound simultaneously in one turn.

### SUMMARY OF INVENTION

### Problems to be Solved by Invention

When the round wire is wound in multiple layers around the winding portion of the bobbin, it is important to uniformly wind the first layer in alignment. However, when two round wires are wound simultaneously in one turn using the automatic winding wire machine, in many cases, the round wire in the first layer could not be arranged at the predetermined position. Furthermore, when the round wires in the first layer could not be arranged in alignment, the round wires in each subsequent layer cannot be arranged in alignment, so there will be gaps between adjacent round wires, and in some cases, the round wire fell off to a layer one layer below the layer in which the round wire should exist. Therefore, the speed of the automatic winding wire machine is slowed down, and the operator manually guides and aligns the round wires, resulting in poor productivity.

In addition, the stress of the round wire in contact with the wall portion deforms the wall portion, changing the size of the space to be wound later, and the predetermined number of turns and the number of layers may not be wound. In some cases, there was also a risk that the wall portion would crack.

The present disclosure is achieved to address the above-described problem, and the objective is to provide the coil component and the manufacturing method of the coil component, which can easily perform aligned winding in multiple layers and improve production efficiency even when winding is performed by the automatic winding wire machine.

### Means to Solve the Problem

To address the above-described problem, a coil component of the present disclosure includes:
a plurality of coils including round wires arranged in alignment and wound in multiple layers; and
a bobbin around which the coils are wound,
in which the plurality of coils are arranged adjacently along winding axis direction; and
in which the bobbin comprising:
   a winding portion around which the coils are wound;
   a flange portion provided at both ends of the winding portion in the winding axis direction; and
   a wall portion provided between adjacent coils and standing from the winding portion,
in which the flange portion comprising:
   an opening through which the round wires are pulled out; and
   an inclined guide spreading toward the opening,
in which the winding portion comprising:
   a groove portion in which the round wires as the first layer is fitted; and
   a step provided between the flange portion and the groove portion and protruding from the winding portion,
      in which the wall portion includes different standing angles on side surfaces perpendicular to the winding axis direction.

In addition, to address the above-described problem, a method for manufacturing a coil component wherein a plurality of coils including round wires arranged in alignment and wound in multiple layers are wound around a bobbin, the method of the present disclosure includes:
a preparation step of setting the bobbin in an automatic winding machine;
a step arranging two round wires in parallel and guiding the two round wires to a winding portion of the bobbin after the preparation step; and
an automatic winding step winding the two round wires around the winding portion by the automatic winding machine,
in which the bobbin comprising:
   a flange portion provided at both ends of the winding portion in the winding axis direction; and
   a wall portion provided between adjacent coils and standing from the winding portion,
in which the flange portion comprising:
   an opening through which the round wires are pulled out; and
   an inclined guide spreading toward the opening,
in which the winding portion comprising:
   a groove portion in which the round wires as the first layer is fitted; and
   a step provided between the flange portion and the groove portion and protruding from the winding portion,
      in which the wall portion includes different standing angles on side surfaces perpendicular to the winding axis direction.

### Effect of Invention

The coil component and the manufacturing method of the coil component that can easily perform aligned winding in multiple layers and improve production efficiency even when winding is performed by the automatic winding wire machine can be obtained.

### BRIEF DESCRIPTION OF DRAWINGS

FIG. 1 is a perspective view illustrating an entire configuration of the coil component.

FIG. 2 is a perspective view of the bobbin.

FIG. 3 is a top view of the bobbin.

FIG. 4 is a schematic diagram illustrating the side shape of the wall portion.

FIG. 5 is a schematic diagram illustrating a state in which the round wire according to an embodiment is led to the winding portion.

FIG. 6 is a schematic diagram illustrating a state in which a conventional round wire is led to a winding portion.

FIGS. 7A to 7C are schematic diagrams illustrating how the round wire is wound in multiple layers, in which 7A illustrates the first layer wound state, 7B illustrates the second layer wound state, and 7C illustrates a state in which winding is completed in one winding space.

FIG. 8 is a schematic diagram illustrating a lamination state of the second layer of the coil component having no step.

FIG. 9 is a schematic diagram illustrating a state of the wall portion in the coil component that does not have inclined side surfaces.

### EMBODIMENTS

### Embodiment

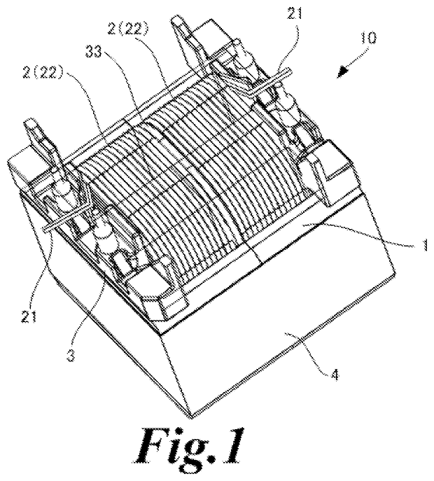

A coil component according to an embodiment will be described with reference to the figures. FIG. 1 is a perspective view illustrating the entire configuration of the coil component. Note that, in each drawing, for ease of understanding, there are cases where dimensions, positional relationships, ratios, shapes, etc. may be emphasized, and there are cases where configuration members may be omitted, and the present disclosure is not limited thereto.

The coil component includes a core 1, a coil 2, and a bobbin 3, as illustrated in FIG. 1. The core 1 contains a magnetic material, and for example, a dust core, a ferrite core, a laminated steel plate, a metal composite core, or the like can be used. The metal composite core is a magnetic body formed by kneading magnetic powder and resin, and curing the resin.

The core 1 is formed by a pair of E-shaped core member in the same shape and size. The E-shaped core member includes three legs extending parallel to the winding axis direction, and the three legs are arranged side by side so that the extending directions are parallel. That is, the E-shaped core includes a middle leg which is centrally located and around which the coil 2 is wound, and a pair of outer legs arranged so as to interpose the middle legs therebetween.

The E-shaped core also has a yoke portion connecting the middle leg and the pair of outer legs. The core 1 has a substantially θ-shape with two annular shapes by joining each middle legs and each pair of outer legs of the pair of E-shaped cores with an adhesive or the like. A tape 4 is wound around the outer periphery of the core 1, and each member is fixed by the tape 4 so as not to be disassembled.

The coil 2 is formed by a single conductive round wire 22 which is insulation-coated by, for example, enamel. The coil 2 is formed by winding the round wire 22 in a cylindrical shape while displacing the winding position in the winding axis direction. The coil 2 has a lead wire 21 that is an end portion of the round wire 22, and the lead wire 21 is electrically connected to an external device. In this embodiment, two coils 2 are provided and arranged adjacent to each other in the winding axis direction.

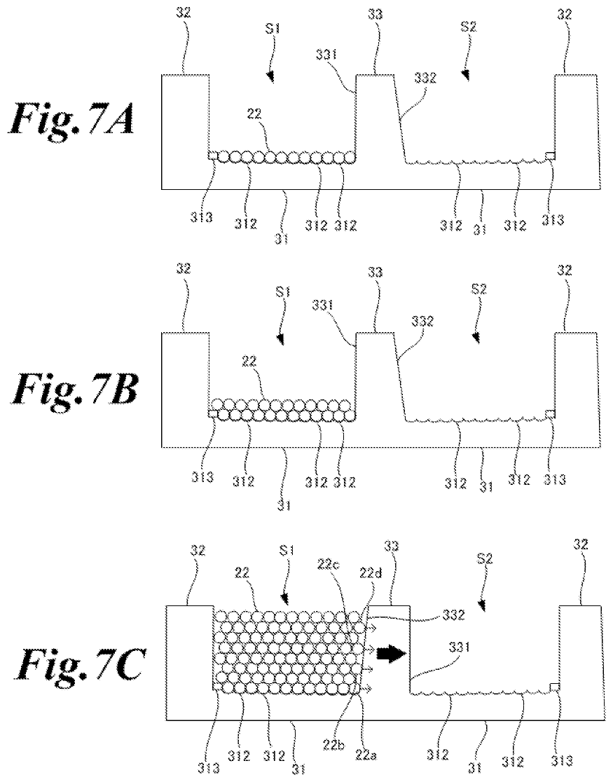

The coil 2 is formed by aligned-winding in which the round wire 22 is wound uniformly. When the round wire 22 reaches the end of the bobbin 3 from the winding start position, the round wire 22 is folded back and wound, and when it returns to the winding start position, the round wire 22 is further folded back and wound again. That is, the coil 2 is formed by winding round wire 22 arranged in alignment into multiple layers. The round wires 22 in the second and subsequent layers are arranged between the round wires 22 in the previous layer (see FIGS. 7B and 7C).

The bobbin 3 is an insulating member that insulates the core 1 and the coil 2 or between the coils 2. That is, the bobbin 3 is provided between the core 1 and the coil 2 or between two coils 2. The bobbin 3 is made of resin. Types of resin for the bobbin 3 may be, for example, epoxy resin, unsaturated polyester resin, urethane resin, BMC (Bulk Molding Compound), PPS (Polyphenylene Sulfide), PBT (Polybutylene Terephthalate), and compositions thereof. As the resin of the bobbin 3, for example, a thermosetting resin such as a phenolic resin may be used. Note that thermally conductive filler may be mixed with the resin.

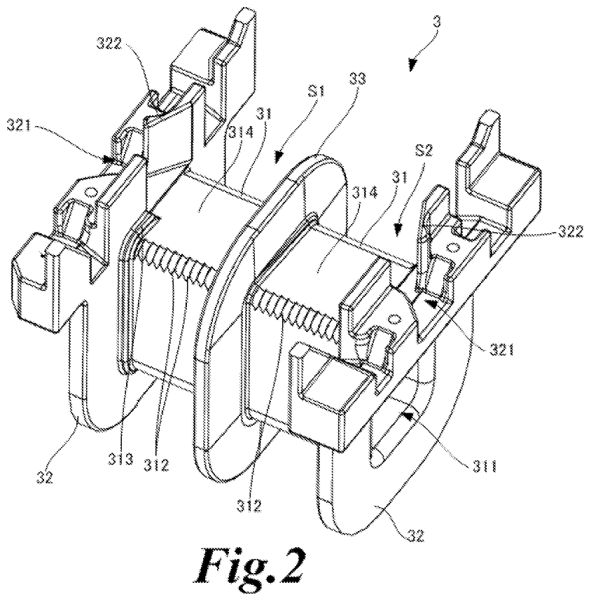

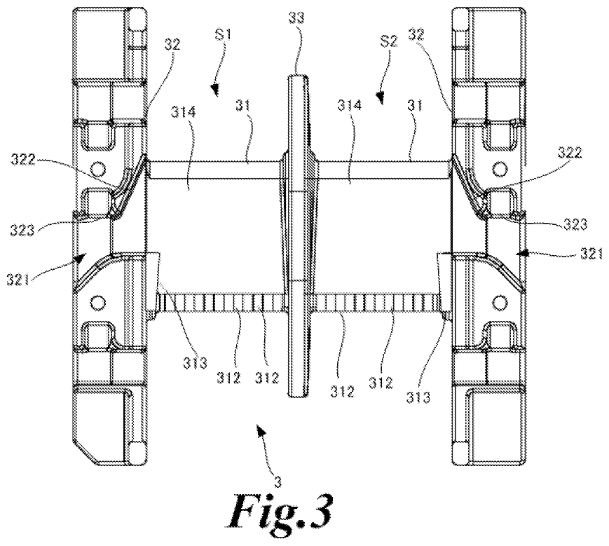

FIG. 2 is a perspective view of the bobbin 3, and FIG. 3 is a top view of the bobbin 3. The bobbin 3, as shown in FIG. 2, has a winding portion 31, a flange portion 32 and a wall portion 33. The flange portion 32 extends in the shape of an angular ring from both ends of the winding portion 31 in the winding axis direction. The wall portion 33 extends in the shape of an angular ring from the central portion of the winding portion 31 in the winding axis direction.

The winding portion 31 is wound with the coil 2. Spaces defined by the winding portion 31, the flange portion 32 and the wall portion 33 are winding spaces S1 and S2 of the coil 2. The winding portion 31 is a substantially rectangular cylindrical member when viewed from the winding axis direction. The winding portion 31 has, on an end face orthogonal to the winding axis, a through hole 311 along the winding axis. The middle leg of the core 1 is inserted into the through hole 311. That is, the winding portion 31 is interposed between the coil 2 and the middle leg of the core 1 to insulate the coil 2 and the core 1.

The winding portion 31 has grooves 312 in which the first layer of the round wire 22 is fitted. The grooves 312 are recesses in which the surface of the winding portion 31 is depressed. The grooves 312 are provided at the corner portion of the winding portion 31. Specifically, the grooves 312 are provided at the corner portion on the side where the lead wire 21 of a lead wire side end surface 314 of the winding portion 31 is not led out. The lead wire side end surface 314 refers to an end surface of the winding portion 31 that is parallel to the winding axis and from which the lead wire 21 is led out. In this embodiment, the grooves 312 is provided only at one corner portion of the winding portion 31, however lead wire may be provided at each corner portion of the winding portion 31.

The size of the grooves 312 in the winding axis direction is slightly larger than the wire diameter of the round wire 22. In addition, the depth of the grooves 312 is, for example, less than half the wire diameter of the round wire 22, although it is not limited thereto.

The grooves 312 are provided by the number of the round wires 22 arranged in the first layer. The plurality of grooves 312 are arranged adjacently from the wall portion 33 toward the flange portion 32 along the winding axis. The grooves 312 are not arranged up to the flange portion 32, and a step 313 is provided between the grooves 312 and the flange portion 32.

The step 313 protrudes toward the coil 2 from the end surface parallel to the winding axis direction of the winding portion 31. The upper end of the step 313 is positioned at the same height as the upper end of the first-layer round wire 22 when the first-layer round wire is fitted into the grooves 312. In other words, the step 313 protrudes by a length obtained by subtracting the depth of the groove 312 from the wire diameter of the round wire 22. The step 313 is connected to the flange portion 32. The length of the step 313 in the winding axis direction is equal to or less than the wire diameter of the round wire 22. In other words, the step 313 extends from the flange portion 32 in the winding axis direction by a distance equal to or less than the wire diameter of the round wire 22.

The step 313 is provided on the lead wire side end surface 314 and extends from the lead wire side end surface 314 to the back surface of the lead wire side end surface 314 along the flange portion 32. The back surface of the lead wire side end surface 314 is the end face on the opposite side of the lead wire side end surface 314. That is, the step 313 is provided over three surfaces of the winding portion 31. Further, as shown in FIG. 3, the step 313 arranged on the lead wire side end surface 314 spreads from the corner portion where the grooves 312 are provided toward the corner portion on the opposite side. In other words, the length in the winding axis direction of the step 313 arranged on the lead wire side end surface 314 increases as the distance from the groove 312 increases. As will be described later, when two round wires 22 are wound in one turn, the longest part is equal to or greater than the wire diameter of one wire of round wire 22 and less than the wire diameter of two wires. When one round wire 22 is wound by one turn, the longest part is less than the diameter of one round wire 22.

The flange portion 32 extends from the entire circumference of the end portion of the winding portion 31 and spreads outward perpendicular to the winding axis direction. The flange portion 32 is provided with an opening 321 through which the lead wire 21 passes. The lead wire 21 extends outside through the opening 321. The opening 321 is provided at the center part of the side of the lead wire side end surface 314 perpendicular to the winding axis.

The flange portion 32 has an inclined guide 322. The inclined guide 322 is slanted and spreads toward the opening 321 from the corner portion of the lead wire side end surface 314 where the groove 312 is not provided. The inclined guide 322 is connected to an opening edge 323 that forms the edge of the opening 321. The connecting angle between the inclined guide 322 and the opening edge 323 is an obtuse angle. The lead wire 21 is guided to the opening 321 by the inclined guide 322.

The wall portion 33 stands from the entire periphery of the central part in the winding axis direction of the winding portion 31. That is, the wall portion 33 spreads outward perpendicular to the winding axis direction. The wall portion 33 is interposed between the winding spaces S1 and S2 of the coil 2 and insulates between the coils 2.

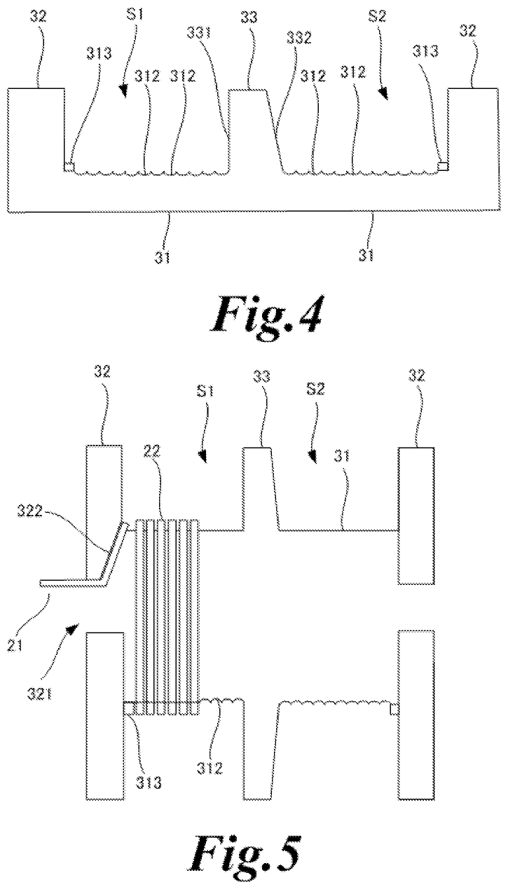

FIG. 4 is a diagram schematically illustrating the wall portion 33. As shown in FIG. 4, of the side surfaces of the wall portion 33 perpendicular to the winding direction, one side surface is a vertical side surface 331 and the other side surface is an inclined side surface 332. That is, the side surfaces of the wall portion 33 perpendicular to the winding axis direction have different standing angles. The vertical side surface 331 stands up perpendicularly to the winding portion 31. The inclined side surface 332 stands up while being inclined toward the vertical side surface 331 with respect to the direction perpendicular to the winding portion 31. The wall portion 33 has the vertical side surface 331 on the side of the space to be wound first, and the inclined side surface 332 on the side of the space to be wound later. In the present embodiment, since the winding is started from the winding space S1, the side surface on the winding space S1 side is the vertical side surface 331, and the side surface on the winding space S2 side is the inclined side surface 332. Note that the vertical side surface 331 and the inclined side surface 332 of the wall portion 33 are in a state before the round wire 22 is wound, and do not represent a shape after winding.

(Winding of the Round Wire)

Next, a method of producing the coil 2 by winding the round wires 22 around the bobbin 3 will be described. First, the round wires 22 are wound in the winding space S1. The coil 2 is wound in alignment in which the round wires 22 are uniformly wound, and the round wires 22 wound in alignment are multi-layered. Two round wires 22 are arranged in parallel and wound. That is, two round wires 22 are wound in one turn.

The round wires 22 are wound by the automatic winding machine. That is, the bobbin 3 is set in the automatic winding machine and wound mechanically.

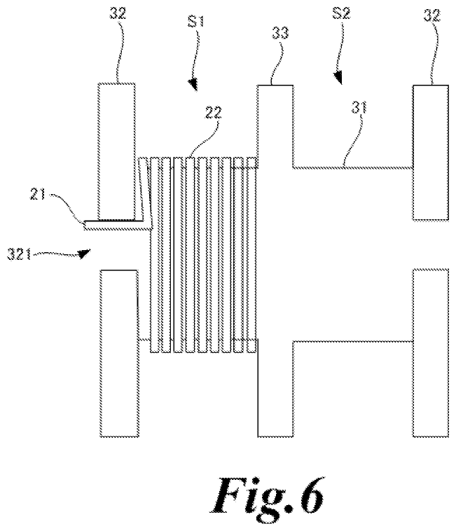

The round wires 22 are inserted through the opening 321 and guided to the winding portion 31 by the inclined guide 322, as illustrated in FIG. 5. The round wires 22 are gently bent by the inclined guide 322 and guided to the winding portion 31. For example, as illustrated in FIG. 6, when the round wires 22 are bent at a right angle without the inclined guide 322 provided on the flange portion 32, the bent portion of the round wires 22 swells toward the winding portion 31, and there is a risk of contact with the round wire 22 wound around the winding portion 31. When they come into contact with each other, the round wires 22 cannot be wound at the predetermined position, the round wires 22 cannot be wound in alignment, and there is a possibility that the predetermined number of turns cannot be accommodated in the winding space S1. However, in the present embodiment, the round wires 22 are prevented from swelling into the winding portion 31 by the inclined guide 322.

Then, the bobbin 3 set in the automatic winding machine is rotated. In the present embodiment, the round wires 22 are wound around the winding space S1 by rotating the bobbin 3 clockwise. That is, the round wires 22 pass from the lead wire side end surface 314 to the corner portion where the groove 312 is not provided, the opposite side of the lead wire side end surface 314, and go to the corner portion having the groove 312. As illustrated in FIG. 7A, the round wires 22 are fitted into the grooves 312 one by one when they reach the grooves 312. The round wires 22 wound in the first turn fit into the two lateral grooves 312 of the step 313. Then, the rotation of the bobbin 3 is repeated until the round wires 22 reach the wall portion 33. Thus, the round wires 22 of the first layer fit into the grooves 312 and are arranged in alignment.

When the round wires 22 reach the wall portion 33, as illustrated in FIG. 7B, they are folded back to wind the second layer of the coil 2. That is, the round wires 22 are wound from the wall portion 33 toward the flange portion 32. The round wires 22 forming the second layer are arranged between the adjacent round wires 22 of the first layer. Since the first layer is aligned, the second and subsequent layers are also aligned.

Here, since the round wires 22 are wound while shifting the winding position in the winding axis direction, as illustrated in FIG. 8, the round wires 22 of the first layer are not in contact with the flange portion 32, and a gap is generated. When this gap is large, there is a risk that the round wires 22 of the second layer would fall into this gap.

However, by providing the step 313 between the flange portion 32 and the round wire 22 of the first layer, the round wires 22 of the second layer are supported by the step 313, and the round wires 22 are prevented from falling off. Therefore, the round wires 22 in the second layer are arranged with a desired number of turns.

When the round wires 22 reach the flange portion 32, they are folded back and wound from the flange portion 32 toward the wall portion 33, the round wires 22 of the third layer are also arranged between the adjacent round wires 22 of the second layer. By repeating this to obtain the predetermined number of layers, the coil 2 having the predetermined number of layers laminated is wound around the bobbin 3.

By laminating the round wires 22, it occurs that the round wires 22 abut against the wall portion 33. For example, as illustrated in FIG. 7C, the first-layer round wire 22a, the third-layer round wire 22b, the fifth-layer round wire 22c, and the seventh-layer round wire 22d contact the wall portion 33. The stress of the round wires 22a, 22b, 22c, and 22d in contact with the wall portion 33 pushes the wall portion 33 toward the winding space S2.

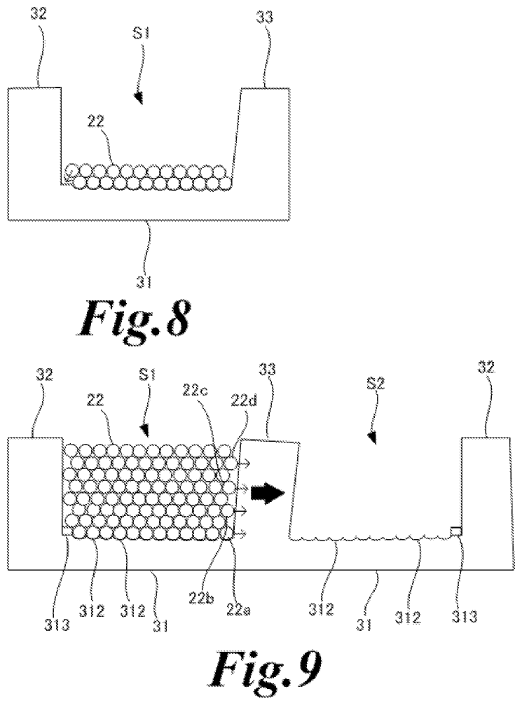

If, as illustrated in FIG. 9, the wall portion 33 is not provided with the inclined side surface 332 and both side surfaces are vertical surfaces, the side surface of the wall portion 33 on the side of the winding space S2 is deformed by the stress of the round wires 22a, 22b, 22c, and 22d.

Therefore, the size of the winding space S2 changes, and there is a risk that the predetermined number of turns or the number of layers cannot be wound.

However, in the present embodiment, it is assumed in advance that the wall portion 33 would be deformed, and the inclined side surface 332 is provided on the side surface on the winding space S2 side of the wall portion 33. That is, the inclined side surface 332 is inclined by the assumed deformation amount. Therefore, as illustrated in FIG. 7C, the side surfaces of the wall portion 33 after the winding in the winding space S1 is completed form the inclined side surface 332 on the winding space S1 side and the vertical side surface 331 on the winding space S2 side. That is, the vertical side surface 331 and the inclined side surface 332 of the wall portion 33 are switched before and after the round wires 22 are wound around the winding space S2. In this way, the winding space S2 is maintained with the predetermined space. The round wires 22 are wound in the winding space S2 as in the winding space S1, and the round wires 22 are wound in both the winding spaces S1 and S2.

(Demonstration Experiment)

Next, the bobbins 3 of Example and Comparative Examples 1 to 4 were produced, and the winding times of the round wires 22 were measured. The bobbin of the Example includes (1) the inclined guide 322, (2) the step 313, (3) the groove 312, and (4) the inclined side surface 332 of the wall portion 33.

Comparative Example 1 includes (2) the step 313, (3) the groove 312, and (4) the inclined side surface 332 of the wall portion 33, but does not include (1) the inclined guide 322. Comparative Example 2 includes (1) the inclined guide 322, (3) the groove 312, and (4) the inclined side surface 332 of the wall portion 33, but does not include (2) the step 313. Comparative Example 3 includes (1) the inclined guide 322, (2) the step 313, and (4) the inclined side surface 332 of the wall portion 33, but does not include (3) the groove 312. Comparative Example 4 includes (1) the inclined guide 322, (2) the step 313, and (3) the groove 312, but does not include (4) the inclined side surface 332 of the wall portion 33.

The only difference between the configurations of the Example and Comparative Examples 1 to 4 is the presence or absence of each of the above configurations (1) to (4), and the other configurations are the same.

The bobbins 3 of these Example and Comparative Examples 1 to 4 were set in the automatic winding machine, and the round wires 22 were wound in alignment and in multiple layers. Two round wires 22 were arranged in parallel and two wires were wound at the same time. The round wires 22 were wound around the winding portion 31 by rotating the bobbin 3 around the axis of the winding portion 31 of the bobbin 3 using the automatic winding machine. The rotation condition is a rotation speed of 2 times per second. First, the round wires 22 were wound around the winding space S1 and then wound around the winding space S2. Table 1 shows the winding results.

TABLE 1

| | | Comparative | Comparative | Comparative | Comparative |
|---|---|---|---|---|---|
| | Examples | Example 1 | Example 2 | Example 3 | Example 4 |
| (1) Inclined guide | Included | Not included | Included | Included | Included |
| (2) Step | Included | Included | Not included | Included | Included |
| (3) Groove | Included | Included | Included | Not included | Included |
| (4) Inclined surface | Included | Included | Included | Included | Not included |
| of wall portion | | | | | |
| Winding time | about ⅕ | 1 | 1 | 1 | 1 |
| Winding result | Wound | Not good | Not good | Not good because the 1st | Not good because the |
| | without | because the | because the | layer was not arranged in | wall was deformed and |
| | problems | number of turns | round wire that | alignment, gaps were | the dimensions of the |
| | | required for the | should be on the | generated and the round | coil space for the later |
| | | 1st layer could | 2nd layer fell | wires that should be on | winding changed, and |
| | | not be | into the 1st | the 2nd layer fell off. | the number of round |
| | | accomodated | layer | | wires that should be |
| | | | | | accomodated in each |
| | | | | | layer did not fit. |

As shown in Table 1, the round wires 22 were wound in alignment and in multiple layers without any problems in the Example provided with the above (1) to (4). On the other hand, Comparative Examples 1 to 4, which did not have even one of the above (1) to (4), had the following problems.

In Comparative Example 1, which does not include (1), the bent portion of the round wires 22 swelled in the winding portion 31 after passing through the opening 321, and the number of turns required for the first layer could not be accommodated. In Comparative Example 2, which does not include (2), gaps were generated between the flange portion 32 and the groove 312, so that the round wires 22 that should be arranged in the second layer fell into the first layer.

In Comparative Example 3, which does not include (3), the round wires 22 are not evenly arranged in alignment in the first layer, and gaps were generated between the adjacent round wires 22, and the round wires 22 arranged in the second layer are fell into in the first layer. In Comparative Example 4, which does not include (4), the wall portion 33 is deformed, the dimension of the winding space S2 in the winding axis direction changes, and in the winding space S2, the number of turns that should be accommodated in each layer could not be wound.

Thus, in Comparative Examples 1 to 4, when a problem occurs, the automatic winding machine is stopped and returned to the point where the problem occurred, or restarted from the beginning, after that, the rotating speed was slowed down, and the worker guided the round wire 22 by hand to wind it, which took a considerable amount of time. The winding times of Comparative Examples 1 to 4 were all about the same.

On the other hand, the Example that could wound without any problem can be wound smoothly without stopping the automatic winding machine in the middle, and winding was completed in about ⅕ of the winding time of Comparative Examples 1 to 4. The winding time referred to here refers to the time from when the round wires 22 are wound in the winding spaces S1 and S2 to when it finishes winding.

(Effect)

As described above, the coil component 10 of the present embodiment includes a plurality of coils 2 including round wires 22 arranged in alignment and wound in multiple layers and the bobbin 3 around which the coils 2 are wound. The bobbin 3 includes the winding portion 31 around which the coils 2 are wound, flange portion 32 provided at both ends of the winding portion 31 in the winding axis direction, and the wall portion 33 provided between the adjacent coils 2 and standing from the winding portion 31. The flange portion 32 includes the opening 321 through which the round wires 22 are pulled out and the inclined guide 322 that spreads toward the opening 321. The winding portion 31 includes the groove portion 312 in which the round wire 22 as the first layer is fitted, and a step 313 provided between the flange portion 32 and the groove portion 312 and protrudes from the winding portion 31 corresponding to the size of the wire diameter of the round wire 22. The wall portion 33 includes different standing angles on the side surfaces perpendicular to the winding axis direction, and includes a vertical side surface 331 and an inclined side surface 332.

By including the inclined guide 322 and the groove 312, the round wires 22 arranged in the first layer can be arranged in alignment. In particular, by including the groove 312, even when the wire diameter of the round wire 22 varies, it can be aligned by fitting into the groove 312.

By including the step 312, it is possible to prevent the round wires 22 arranged in the second layer from falling off to the first layer. Therefore, the round wires 22 can be aligned in the third and subsequent layers. Furthermore, since the wall portion 33 included the inclined side surface 332 that is inclined in advance for deformation, even when the wall portion 33 is deformed by the stress of the round wires 22 in contact with the wall portion 33, the size of the winding space S2 can be secured, also in the winding space S2, the coil 2 with the predetermined number of turns and layers can be formed.

The winding portion 31 includes the lead wire side end surface 314 which is the end face on the side where the opening 321 from which the round wires 22 are lead out is provided, and the step 313 extends from the lead wire side end surface 314 to the opposite end face of the lead wire side end surface 314. As a result, the round wires 22 in the second layer adjacent to the flange portion 32 are supported by the step 313 over about half the circumference, they can be supported more stable than when the step 313 is short. Therefore, when the coil 2 is laminated in multiple layers, the stress in the lower layer direction increases, however even when the third and subsequent layers are laminated and the stress in the lower layer direction related to the round wires 22 increases, it is possible to prevent the round wires 22 from falling off to the first layer, and to maintain the aligned arrangement of the second layer.

Further, the width of the step 313 provided on the lead wire side end surface 314 in the winding axis direction increases as the inclined guide 322 is approached. When the round wires 22 are wound, the round wires 22 are wound obliquely because it is wound while shifting in the winding axis direction. Therefore, by making the shape of the step 313 match the inclination angle of the round wire 22, the step 313 also serves as a guide for the round wires 22 forming the first layer. Therefore, alignment winding of the first layer can be performed more accurately.

In the manufacturing method of the coil component according to the present embodiment, the round wires 22 are wound by the automatic winding machine to manufacture the coil component 10 in which the round wires 22 are laminated in multiple layers. Two round wires 22 are wound side by side in parallel, and two round wires 22 are wound in one turn. The bobbin 3 includes the wall portion 33 including the inclined guide 322, the grooves 312, the steps 313, and the inclined side surfaces 332. As a result, automatic winding enables aligned winding in multiple layers, compared to the case where the bobbin 3 does not include any one of the inclined guide 322, the groove 312, the step 313 and the wall portion 33 having the inclined side surface 332, the round wires 22 can be wound in about ⅕ of the time. In particular, in the present embodiment, two round wires 22 are wound in one turn, so productivity is dramatically improved compared to the case where one round wire 22 is wound in one turn.

### Other Embodiment

In the description herein, although embodiments according to the present disclosure are described, said embodiments are only provided as examples and are not intended to limit the scope of claims. The above-described embodiments may be implemented by other various forms, and various omissions, replacements, and changes may be made without departing from the scope of claims. The embodiments and modifications thereof are included in the invention described in the claims and equivalent ranges thereto, as well as in the scope and abstract of the invention.

In the above embodiment, the wall portion 33 includes the vertical side surface 331 and the inclined side surface 332 on the assumption that the wall portion 33 is deformed. However, the wall portion 33 does not have to include the inclined side surface 332. For example, the thickness of the wall portion 33 in the winding axis direction may be increased to prevent the deformation of the wall portion 33 itself. The thickness of the wall portion 33 may be appropriately selected according to the length of the winding portion 31 in the winding axis direction and the number of layers of the round wire 22.

Further, the wall portion 33 may be prevented from being deformed not by the thickness in the winding axis direction but by the material. The wall portion 33 may be made of a highly rigid material. A material with high rigidity may be appropriately selected depending on the length of the winding portion 31 in the winding axis direction and the number of layers of the round wire 22, examples thereof include PPS (Polyphenylene Sulfide).

In the above-described embodiment, the length of the step 313 in the winding axis direction increases as the distance from the groove 312 increases in order to rotate the bobbin 3 clockwise, when the bobbin 3 is rotated counterclockwise, the shape of the step 313 is reversed. That is, the step 313 is tapered away from the groove 312.

### REFERENCE SIGN

10: coil component
1: core
2: coil
21: lead wire
22: round wire
3: bobbin
31: winding portion
311: through hole
312: groove
313: step
314: lead wire side end surface
32: flange portion
321: opening
322: inclined guide
33: wall portion
331: vertical side surface
332: inclined side surface
4: tape
S1, S2: winding space

What is claimed is:

1. A coil component comprising:
a plurality of coils including round wires arranged in alignment and wound in multiple layers; and
a bobbin around which the coils are wound,
wherein the plurality of coils are arranged adjacently along winding axis direction; and
wherein the bobbin comprising:
a winding portion around which the coils are wound;
a flange portion provided at both ends of the winding portion in the winding axis direction; and
a wall portion provided between adjacent coils and standing from the winding portion,
Wherein the flange portion comprising:
an opening through which the round wires are pulled out; and
an inclined guide spreading toward the opening,
Wherein the winding portion comprising:
a groove portion in which the round wires as the first layer is fitted; and
a step provided between the flange portion and the groove portion and protruding from the winding portion,
wherein the wall portion includes different standing angles on side surfaces perpendicular to the winding axis direction.

2. The coil component according to claim 1, wherein:
the winding portion includes a lead wire side end surface provided with the opening through which the round wires are lead out, and
the step extends from the lead wire side end surface to an opposite end face of the lead wire side end surface.

3. The coil component according to claim 2, wherein a width of the step provided on the lead wire side end surface in the winding axis direction increases as the inclined guide is approached.

4. A method for manufacturing a coil component wherein a plurality of coils including round wires arranged in alignment and wound in multiple layers are wound around a bobbin, the method comprising:
a preparation step of setting the bobbin in an automatic winding machine;
a step arranging two round wires in parallel and guiding the two round wires to a winding portion of the bobbin after the preparation step; and
an automatic winding step winding the two round wires around the winding portion by the automatic winding machine,
wherein the bobbin comprising:
a flange portion provided at both ends of the winding portion in the winding axis direction; and
a wall portion provided between adjacent coils and standing from the winding portion,
Wherein the flange portion comprising:
an opening through which the round wires are pulled out; and
an inclined guide spreading toward the opening,
Wherein the winding portion comprising:
a groove portion in which the round wires as the first layer is fitted; and
a step provided between the flange portion and the groove portion and protruding from the winding portion,
wherein the wall portion includes different standing angles on side surfaces perpendicular to the winding axis direction.
